(19) United States
(12) Patent Application Publication
(10) Pub. No.: US 2007/0131291 A1
(43) Pub. Date: Jun. 14, 2007

(54) Manual valve of hydraulic pressure control system for automatic transmission

(76) Inventor: Jin Hee Lee, Seongnam-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/580,003

(22) Filed: Oct. 12, 2006

(30) Foreign Application Priority Data
Dec. 14, 2005 (KR) 10-2005-0123173

(51) Int. Cl. F15B 13/04

(52) U.S. Cl. 137/625.69

(57) ABSTRACT

A manual valve of a hydraulic pressure control system for an automatic transmission includes: a valve body that includes an input port and two reverse range pressure supply ports for supplying a hydraulic pressure from the input port to two friction elements; and a valve spool that is disposed in the valve body and that is connected to a select lever, wherein at least one exhaust passage is formed on a land of the valve spool that opens/closes the two reverse range pressure supply ports of the valve body.

### CROSS-REFERENCE TO RELATED APPLICATION

This application claims priority to and the benefit of Korean Patent Application No. 10-2005-0123173 filed in the Korean Intellectual Property Office on Dec. 14, 2005, the entire contents of which are incorporated herein by reference.

### BACKGROUND OF THE INVENTION

(a) Field of the Invention

The present invention relates to a manual valve that is applied to a hydraulic pressure control system of an automatic transmission for a vehicle. More particularly, the present invention relates to a manual valve that optimally controls an automatic transmission fluid (ATF) that is exhausted when the vehicle is shifted from reverse to neutral in various circumstances, such as at very low temperatures and at room temperature.

(b) Description of the Related Art

In general, automatic transmissions control a plurality of solenoid valves based on speed of the vehicle and throttle valve opening, etc., so as to control a hydraulic pressure. Accordingly, since a shift gear of a target shift range is moved by the hydraulic pressure, shifting occurs automatically.

If a driver moves a select lever into a desired shift range, ports of the manual valve of the hydraulic pressure control system are changed such that the hydraulic pressure is supplied from a hydraulic pump to a plurality of operational elements, which are operated by the hydraulic pressure. In particular, such operational elements are selectively operated according to the duty cycles of the solenoid valves, such that the shift is accomplished.

In a conventional manual valve, hydraulic pressure is exhausted only through exhaust ports when the vehicle is shifted from reverse to neutral. Accordingly, since release pressure is not controlled, the following problems may occur:

Since release time of a reverse range pressure is not controlled, the hydraulic pressure is always exhausted through the exhaust ports in the same way despite different circumstances, which include at room temperature, when viscosity of a transmission fluid is low, and at very low temperatures, when viscosity of the transmission fluid is high.

At room temperature when viscosity of the transmission fluid is low, since the transmission fluid is exhausted quickly, shift shock may occur. At very low temperatures when the viscosity of the transmission fluid is high, since exhaust time of the transmission fluid is extended, that is, since a release of a friction element is insufficient, the vehicle may unintentionally reverse.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a manual valve of a hydraulic pressure control system for an automatic transmission that optimally controls automatic transmission fluid (ATF) that is exhausted when the vehicle is shifted from reverse to neutral in various circumstances, such as at very low temperatures and at room temperature.

An exemplary embodiment of the present invention provides a manual valve of a hydraulic pressure control system for an automatic transmission that includes a valve body that includes an input port and two reverse range pressure supply ports for supplying a hydraulic pressure from the input port to two friction elements; and a valve spool that is disposed in the valve body and connected to a select lever, wherein at least one exhaust passage is disposed on a land that opens/closes the two reverse range pressure supply ports. The at least one exhaust passage may include first and second exhaust passages.

The first exhaust passage may include a radial hole connecting a first principal groove to a second principal groove, wherein the first and second principal grooves are formed on surfaces of a land that is disposed at the same position as the two reverse range pressure supply ports when a reverse range is selected; and an axial hole that communicates a middle portion of the radial hole with an exterior.

The second exhaust passage may include an exhausting groove that is formed on a surface of the land between the first and second principal grooves, and that is disposed along the axial direction of the valve spool.

### BRIEF DESCRIPTION OF THE DRAWINGS

FIG. 1 is a circuit diagram showing a hydraulic control system of an automatic transmission according to an exemplary embodiment of the present invention;

FIG. 2 is a perspective view showing a valve spool according to an exemplary embodiment of the present invention;

FIG. 3 is a cross-sectional view taken along the line III-III in FIG. 2;

FIG. 4 is a cross-sectional view taken along the line IV-IV in FIG. 2; and

FIG. 5 is a cross-sectional view showing a manual valve of a hydraulic control system of an automatic transmission according to an exemplary embodiment of the present invention.

### DETAILED DESCRIPTION OF THE PREFERRED EMBODIMENTS

An exemplary embodiment of the present invention will hereinafter be described in detail with reference to the accompanying drawings.

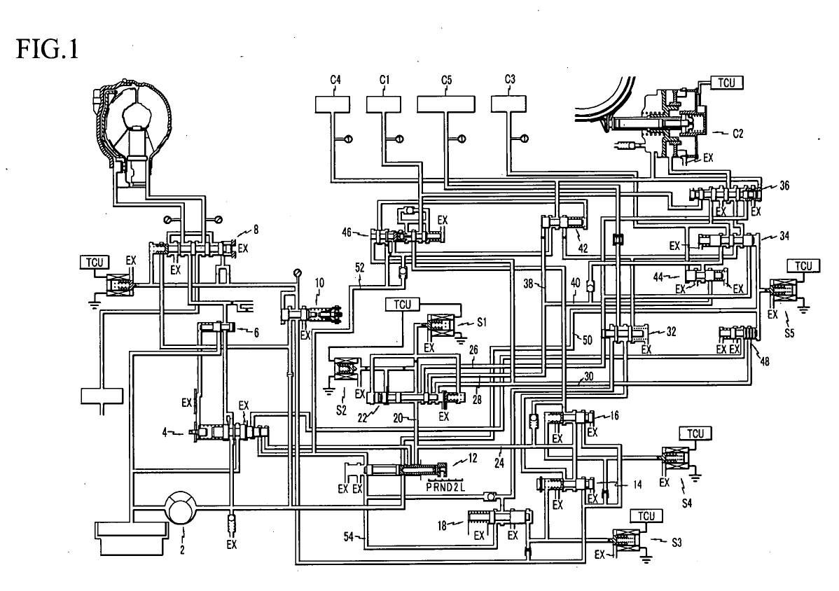

FIG. 1 shows a hydraulic pressure system for explaining an applied state of a manual valve according to an exemplary embodiment of the present invention. The manual valve of the present invention can be applied to not only the hydraulic pressure system as shown in FIG. 1, but also to all hydraulic control systems to which an N-D control valve is applied.

An exemplary hydraulic control system, to which the manual valve of the present invention is applied, will be hereinafter described with reference to FIG. 1. Hydraulic pressure, which is generated from a hydraulic pump 2, is supplied into a pressure regulating valve 4, a torque converter control valve 6, a damper clutch control valve 8, etc.

In addition, a first predetermined portion of the hydraulic pressure is supplied into a reducing valve 10 and a manual valve 12, and then the hydraulic pressure is reduced through the reducing valve 10. A second predetermined portion of the reduced hydraulic pressure is supplied into a first pressure control valve 14 and a second pressure control valve 16 so as to be converted into a control pressure of the shift range.

While the second predetermined portion of the reduced hydraulic pressure is supplied into the first and second pressure control valves 14 and 16, a third predetermined portion thereof is supplied into an N-R control valve 18. In addition, when the manual valve 12 has a drive D range state, a shift control valve 22, which converts a passage according to a control of a first solenoid valve S1 and a second solenoid valve S2, is connected to a line 20 in which the hydraulic pressure moves, such that the shift control valve 22 performs a shift control with the manual valve 12.

A first speed line 24 branches from the line 20. In addition, the line 20 is connected with the first and second pressure control valves 14 and 16, which are controlled by third and fourth solenoid valves S3 and S4, through the first speed line 24 so as to receive a shift control pressure.

A second speed line 26, a third speed line 28, and a fourth speed line 30 are connected to the shift control valve 22. In detail, the second speed line 26 is connected with a 1-2 shift valve 32, a control switching valve 34, and a fail-safe valve 36. The third speed line 28 branches into first and second branch lines 38 and 40, the first branch line 38 being connected with a 2-3/4-3 shift valve 42 and the second branch line 40 supplying the hydraulic pressure into the control switching valve 34 and an end clutch valve 44.

In addition, the fourth speed line 30 connects a rear clutch release valve 46 to the 2-3/4-3 shift valve 42, and one portion of the fourth speed line 30 supplies the hydraulic pressure into the pressure regulating valve 4 through a high-low pressure valve 48 such that a line pressure is regulated.

A timing control pressure line 50 of the manual valve 12 connects the control switching valve 34 to the high-low pressure valve 48 so as to be controlled by a fifth solenoid valve S5.

In addition, when the manual valve 12 has a reverse R range state, while the hydraulic pressure is supplied into a first reverse control line 52, the hydraulic pressure is supplied into a front clutch C4 and a release side chamber of a kick down servo C2 through a rear clutch release valve 46 and the 2-3/4-3 shift valve 42, and is simultaneously supplied as a control pressure to the fail-safe valve 36.

While the hydraulic pressure is supplied into a second reverse control line 54, the hydraulic pressure is supplied into a low-reverse brake C5 through the N-R control valve 18 and the 1-2 shift valve 32.

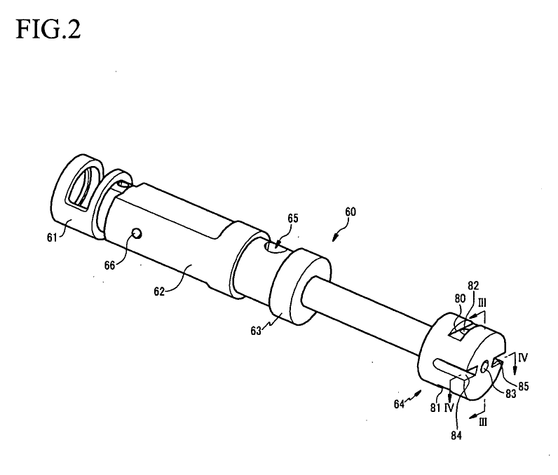

An exemplary manual valve 12, which can be applied to the above-mentioned or other hydraulic control systems, is shown in FIGS. 2 to 4. A valve spool 60, as shown in FIG. 2, includes a connecting part 61, which is configured to be connected to the select lever of a driver's seat (not shown), and first, second, and third lands 62, 63, and 64. Lands 62-64 are formed apart from each other by predetermined gaps according to a port design of the valve body.

In addition, an exhaust hole (not shown) is disposed on the valve spool 60 from an end portion of the connecting part 61 to a portion between the first and second lands 62 and 63, an interior end portion of the exhaust hole is radially connected with an intake hole 65 in the valve spool 60, so that a transmission fluid that flows into the intake hole 65 is exhausted through the exhaust hole and an orifice 66.

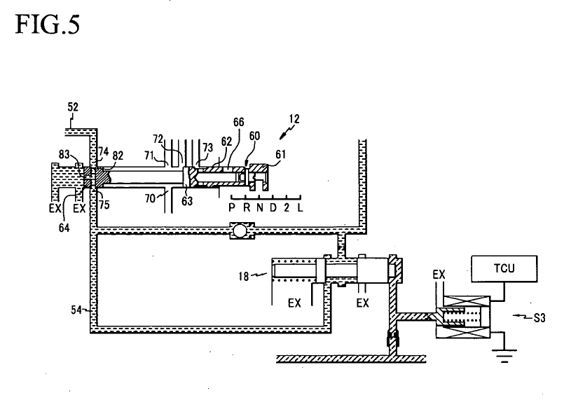

An exemplary valve body in which the valve spool 60 is inserted, as shown in FIG. 5, includes a first port 70 that receives the hydraulic pressure supplied from the hydraulic pump, a second port 71 that supplies the hydraulic pressure from the first port 70 to the timing control pressure line 50, a third port 72 that supplies the hydraulic pressure as control pressure from the first port 70 to the regulator valve 4, a fourth port 73 that supplies the hydraulic pressure from the first port 70 to the shift control valve 22, and fifth and sixth ports 74 and 75 that supply the hydraulic pressure from the first port 70 to the first and second reverse pressure lines 52 and 54 when a reverse R range is selected.

Accordingly, the hydraulic pressure, which is always generated when an engine is running, is first supplied into the first port 70. In the park P range, the supplied hydraulic pressure is exhausted through the intake hole 65 and the orifice 66, while in the reverse R range, the supplied hydraulic pressure is supplied into the fifth and sixth ports 74 and 75. Further, in the neutral N range, the supplied hydraulic pressure is supplied into the second port 71 and the third port 72, and in the drive D range, the supplied hydraulic pressure is supplied into the second, third, and fourth ports 71, 72, and 73.

In such a manual valve 12, the third land 64 has a predetermined width such that the fourth and fifth ports 74 and 75 can be fully accommodated.

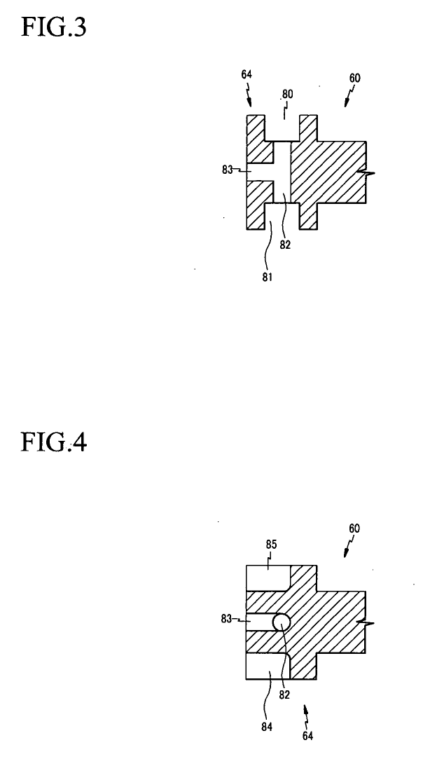

A first exhaust passage may be formed as follows: First and second principal grooves 80 and 81 (FIGS. 2 and 3) with a first predetermined depth are formed on a periphery of a middle portion of the third land 64 such that they are disposed at the same positions as the fourth and fifth ports 74 and 75 (FIG. 5) when the neutral N range is selected. Furthermore, the first and second principal grooves 80 and 81 are respectively positioned to upper and lower portions of the periphery of the third land 64. The principal grooves 80 and 81 communicate with each other by a radial hole 82, which is opened to an exterior by an axial hole 83.

Accordingly, when the reverse R range is shifted into the neutral N range, the transmission fluid, which is supplied into the fifth and sixth ports 74 and 75, is exhausted through holes 82 and 83 of the principal grooves 80 and 81.

Further, a second exhaust passage may be formed as follows. First and second exhausting grooves 84 and 85 (FIGS. 2 and 4) with a second predetermined depth are disposed on a periphery of the third land 64 along the axial direction of the valve spool 60. Furthermore, each inner side end (i.e., an inner surface that is toward the second land 63, in an inner surface of the exhausting grooves) thereof is disposed at the same axial position as the middle portions of the first and second principal grooves 80 and 81, and each exterior side end (i.e., a portion that is outward with respect to the axial direction of the valve spool 60) thereof is open.

Accordingly, when the reverse R range is shifted into the neutral N range, the transmission fluid, which is supplied into the fifth and sixth ports 74 and 75, is exhausted through holes 82 and 83 of the principal grooves 80 and 81, and is also exhausted through the first and second exhausting grooves 84 and 85 at the same time.

The sizes of the holes 82 and 83 and the exhausting grooves 84 and 85 are predetermined according to a design rule of the automatic transmission.

While it has been explained that each inner side end of the exhausting grooves 84 and 85 is disposed at about the same axial position as the middle portions of the principal grooves 80 and 81, each inner side end of the exhausting grooves 84 and 85 may be closer to the second land 63, or may be closer to each outer side end of the exhausting grooves 84 and 85.

If each inner side end of the exhausting grooves 84 and 85 is closer to the second land 63, since the exhausting grooves 84 and 85 are large, the release time is shortened. In addition, if each inner side end is closer to each outer side end of the exhausting grooves 84 and 85, since the exhausting grooves 84 and 85 are small, the release time is delayed. Accordingly, the position of each inner side end may be predetermined according to characteristics of the automatic transmission.

The above-mentioned manual valve 12 has a state like FIG. 5 in the neutral N range state, in which the transmission fluid, which is supplied through the fifth and sixth ports 74 and 75, is exhausted through the holes 82 and 83 of the principal grooves 80 and 81, and is exhausted through the exhausting grooves 84 and 85 at the same time.

An exhaust of the transmission fluid is governed by each size of the holes 82 and 83 and the exhausting grooves 84 and 86. Accordingly, each size may be predetermined such that the release time has a range in which shift shock is not generated when the reverse R range is shifted into the neutral N range.

At low temperatures when viscosity of the transmission fluid is high, if a driver moves the select lever (not shown) a little toward the drive D range, the valve spool 60 moves toward the drive D range, and the size of the exhausting grooves 84 and 85 is enlarged, and as a result the release time is fast.

In addition, at very low temperatures (about 30 degrees below zero), if the third solenoid valve S3 is controlled such that a valve spool of the N-R control valve 18 is moved to the right in FIG. 1, an exhausting port EX is opened, and accordingly, the transmission fluid is directly exhausted from the N-R control valve 18 without being exhausted through the manual valve 12.

As has been explained, according to the present invention, regardless of temperature, the exhaust of automatic transmission fluid (ATF) can be controlled when the reverse R range is shifted into the neutral N range. As a result, shift shock is prevented.

In addition, according to the present invention, even though the viscosity of the transmission fluid is high in a state of very low temperature, the release time can be shortened. As a result, accidents due to a release deficiency of a reverse frictional element can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manual valve of a hydraulic pressure control system for an automatic transmission, comprising:
a valve body comprising an input port and two reverse range pressure supply ports for supplying a hydraulic pressure from the input port to two friction elements; and
a valve spool disposed in the valve body and configured to be connected to a select lever, wherein the valve spool comprises a land that opens and closes the two reverse range pressure supply ports, and the land comprises at least one exhaust passage.

2. The manual valve of claim 1, wherein the at least one exhaust passage comprises first and second exhaust passages.

3. The manual valve of claim 1, wherein the exhaust passage comprises:
a first hole disposed along a first radial direction of the valve spool and connecting a first principal groove to a second principal groove, wherein the first and second principal grooves are disposed on the land at positions that correspond to the two reverse range pressure supply ports when a reverse range is selected, and the first and second principal grooves are disposed along a second radial direction of the valve spool; and
a second hole that is disposed along an axial direction of the valve spool and connects the first hole with an exterior.

4. The manual valve of claim 1, wherein the exhaust passage comprises an exhausting groove that is disposed on the land along an axial direction of the valve spool.

5. The manual valve of claim 2, wherein the first exhaust passage comprises:
a first hole disposed along a first radial direction of the valve spool and connecting a first principal groove to a second principal groove, wherein the first and second principal grooves are disposed on the land at positions that correspond to the two reverse range pressure supply ports when a reverse range is selected, and the first and second principal grooves are disposed along a second radial direction of the valve spool; and
a second hole that is disposed along an axial direction of the valve spool and connects the first hole with an exterior.

6. The manual valve of claim 2, wherein the second exhaust passage comprises an exhausting groove that is disposed on the land along an axial direction of the valve spool.

7. The manual valve of claim 5, wherein the second exhaust passage comprises an exhausting groove that is disposed on the land along the axial direction of the valve spool between the first and second principal grooves.

8. The manual valve of claim 7, wherein:
an inner side end of the exhausting groove is disposed at a substantially same axial position as the principal grooves; and
an exterior side end of the exhausting groove is open.

9. A manual valve of a hydraulic pressure control system for an automatic transmission, comprising:
a valve body comprising a first port that receives a hydraulic pressure supplied from a hydraulic pump, second and third ports that supply the hydraulic pressure of the first port as a control pressure, a fourth port that supplies the hydraulic pressure of the first port as a drive range pressure, and fifth and sixth ports that supply the hydraulic pressure of the first port as a reverse range pressure; and
a valve spool comprising a connecting part configured to be connected to a select lever of a driver's seat, and first, second, and third lands spaced apart from each other by predetermined gaps such that the lands correspond to the ports,
wherein the third land comprises first and second exhaust passages.

10. The manual valve of claim 9,
wherein the first exhaust passage comprises:
a first hole disposed along a first radial direction of the valve spool and connecting a first principal groove to a second principal groove, wherein the first and second principal grooves are disposed at substantially identical positions as the fifth and sixth ports when a reverse range is selected, and the first and second principal grooves are disposed along a second radial direction of the valve spool; and
a second hole, disposed along an axial direction of the valve spool, that connects the first hole with an exterior;
and wherein the second exhaust passage comprises an exhausting groove disposed between the first and second principal grooves, and disposed along the axial direction of the valve spool.

11. The manual valve of claim 10, wherein:
an inner side end of the exhausting groove is disposed at a substantially identical axial position as the principal grooves; and
an exterior side end of the exhausting groove is open.
